(19) United States
(12) Patent Application Publication
(10) Pub. No.: US 2019/0273464 A1
(43) Pub. Date: Sep. 5, 2019

(54) SOLAR ENERGY COLLECTION DEVICES AND SYSTEMS

(71) Applicant: David W. Carroll, Grantsburg, WI (US)

(72) Inventor: David W. Carroll, Grantsburg, WI (US)

(21) Appl. No.: 16/293,527

(22) Filed: Mar. 5, 2019

Related U.S. Application Data
(60) Provisional application No. 62/638,479, filed on Mar. 5, 2018.

(51) Int. Cl. H02S 30/20; H02S 40/38; H02S 40/36; H02S 20/32; H02S 20/10; H02S 40/22; H02S 99/00

(52) U.S. Cl. CPC H02S 30/20; H02S 40/38; H02S 40/36; H02S 99/00; H02S 20/10; H02S 40/22; H02S 20/32

(57) ABSTRACT

Systems for collecting and storing solar energy including a solar energy capture and store device having a plurality of segments arranged in a contiguous row. Immediately adjacent ones of the segments are interconnected by a hinge such that the plurality of segments are transitionable between a collapsed, folded state and an expanded state. A photovoltaic layer is carried by at least one of the segments, and a power storage layer is carried by at least one of the segments. The power storage layer is electrically connected to at least one of the photovoltaic layers. An electronic connection is established between each immediately adjacent pair of segments. An electrical connections terminus delivers stored energy. A do-it-yourselfer (DIY) individual is afforded the ability to install and operate a solar energy collection device with little or no skills in the arena of power provision.

### CROSS-REFERENCE TO RELATED APPLICATIONS

This Non-Provisional patent application claims the benefit of the filing date of U.S. Provisional Patent Application Ser. No. 62/638,479, filed Mar. 5, 2018, the entire teachings of which are incorporated herein by reference.

### BACKGROUND

The present disclosure is directed to devices for collecting solar energy. More particularly, it relates to inexpensive and easy to install solar energy collection devices and systems.

Climate change is a human caused threat to planet life. Human emissions of greenhouse gas (GHG) mostly CO2 and methane are excessive to nature's GHG normal exchanges, and this forms a reflective GHG particulate blanket in the atmosphere. This ‘blanket’ retains excessive solar energy in the Earth's environment in the form of heat while also raining down excessive CO2 into the ocean. This raises ocean temperature, acidity and sea level. Some terrestrial areas will get so hot and humid (Wet Bulb Temperature) that much of human, animal and plant life will be unsustainable. This added energy is thawing permafrost which emits methane captured for millennia. This greatly adds to the GHG imbalance. Thawing of the Arctic, Greenland, Antarctica and glaciers further raises the ocean and floods low-lying heavily occupied lands. In short order the lack of a reflective summer surface ice also means darker waters which adds to ocean warming. Warmer ocean water swells from retained energy too. This elevation change is devastating to low islands and coastal low-level cities. This is further influenced by high-tides and storms such that eventually many cities will be permanently lost. The GHG imbalance has already raised ocean acidity 30% which makes it increasingly difficult for shelled creatures to form protective enclosures. The levels of ocean oxygen are dropping at 4X the rate previously thought. Generally speaking, human emissions have taken us outside nature's narrow and critical window for thriving life.

One especially helpful way to address this challenge is to use more renewable and/or non-polluting energy sources vs. burning fossil fuels. This is especially important as developing countries are greatly increasing energy demands.

Solar power has already proven to be cost/per/watt advantageous vs. all other energy sources. Future solar gain and pricing improvements are likely to double or triple that advantage. Another solar benefit is that can be provided near to use. This reduces transmission and voltage change losses.

As the cost of solar hardware continues to plummet from increased efficiency and high-volume production, the soft costs, mostly installation, continues to rise as a percentage of the cost. Residential application installation costs are now on the order of 60-70% of the total system price. Reasons for this not dropping include solar install labor and skills shortage. Also, panel weight and size of hardware panels (especially when roof mounted), mounting hardware costs (roof or ground) and margins for system suppliers. Further, locations for positioning distributed solar gathering systems is difficult as they take large X-Y areas and often limits installation to the roof. This can be quite difficult to access and mount. Most home owners or “do-it-yourself” (DIY) are simply unwilling to undertake these efforts. Roof mounted systems also invade the roofing and require removal when the roofing requires replacement.

Cloudy days and the dark of night require solar power storage. These storage devices are also demanding of installation expertise.

### SUMMARY

The inventor of the present disclosure has recognized a need to address one or more of the above-mentioned problems.

Some aspects of the present disclosure relate to a system for collecting and storing solar energy. The system includes a solar energy capture and store device having a plurality of segments arranged in a contiguous row. Immediately adjacent ones of the segments are interconnected by a hinge such that the plurality of segments are transitionable between a collapsed, folded state and an expanded state. A photovoltaic layer is carried by at least one of the segments, and a power storage layer is carried by at least one of the segments. The power storage layer is electrically connected to at least one of the photovoltaic layers. An electronic connection is established between each immediately adjacent pair of segments of the plurality of segments. An electrical connections terminus carried by at least one of the plurality of segments for delivering stored energy.

With some devices and systems of the present disclosure, a do-it-yourselfer (DIY) individual is afforded the ability to install and operate a solar energy collection device with little or no skills in the arena of power provision while avoiding the high installation costs and skilled labor associated with conventional home-type solar energy collection systems. With some devices and systems of the present disclosure, roof top installation is not necessary.

As efficiencies of photovoltaic (PV) and power storage achieve substantial improvement, the area required for most residencies is reduced, opening up the opportunity for more formats that may fit into more accessible locations on a property. In some embodiments, the devices and systems of the present disclosure can take advantage of sandwiching these achievements by integrating advanced materials such as “magic alloy” PV with approximately 50% energy efficiency collection, nano-ultra capacitors, and low-cost IC processors and wireless components. Some devices and systems of the present disclosure can optionally take advantage of coming laboratory achievements such as the development of flexible, graphene-based devices that are capable of powering themselves from sunlight as introduced by researchers at the University of Glasgow in a paper entitled “Graphene-Graphite Polyurethane Composites based High-Energy Density Flexible Supercapacitors” as published in Advanced Science.

In some embodiments, the devices of the present disclosure provide a single-stack, accordion-folding energy gathering and storing format. In an unfolded, relatively vertical state, the device uses multiple, ideally-angled surfaces in one strip to make installation simpler and to fit more solar gather locations nearer the power usage. In some embodiments, the device is maintained by a support assembly such that upward facing surfaces angle together to achieve a desired direction to gather the sun's energy at the user's latitude. This folding strip of energy gathering and storing can be better sized to rotate for the purpose of tracking the sun's apparent motion.

The closed accordion format (or collapsed state) closes for easy shipping and handling until erected on a post, a wall or hung between horizontal cables or other features.

In some embodiments, the sandwich of photovoltaic and power storage may be intermittent so only the upward facing segments has photovoltaic. In some embodiments, every other segment to the upward facing segments of the device has a reflective surface.

In some embodiments, the device may be collapsed and readily removable or replaceable from the collector stanchion or wall mount for use as the battery power source for an electric vehicle, a residence or other power required system. In some embodiments, the accordion power collector and storage device may use spacers with power connection and hinges to perform as the accordion spacer between segments of photovoltaic with power storage. In some related embodiments, the spacer with power connection and hinge segments can be alongside such that each is outside of the segments of photovoltaic with power area and thus when stacked as a collapsed accordion for shipping, storage and transfer that the spacer does not make the stack thicker.

In some embodiments, flex circuitry may be the spacer connection between segments of photovoltaic with power storage. In some embodiments, flex circuitry may be the spacer with power connection and hinges segments between the segments of photovoltaic with power storage. In some embodiments, flex circuitry may be the spacer with power connection and act as the hinge segments spacer between the segments of photovoltaic with power storage and located to the side of the segments when the accordion device is folded to collapse into a battery stack. In some embodiments, the photovoltaic and power storage may be mounted to a flex circuit and hold components to manage the device's position using motors that expand or contract or rotate to orient the accordion for best use of the energy collector and storage device.

In some embodiments, each photovoltaic and power storage segment may have many internal dish reflectors to aim light at concentrated inward-aiming photovoltaic to the dish collector. In some embodiments, all segments of the device are photovoltaic with power storage segments.

In some embodiments, the system includes a vertical stanchion holding the device that is resident for motors to position the device. In some embodiments, the device accordion be resident for motors to position the device.

In some embodiments, the device retains sufficient power after use to operate a directional system. In some embodiments, the directional system incorporates a dedicated mobile smart device.

In some embodiments, the system is configured such that the device is positioned above a reflector to bring solar energy to downward aiming segments of the device.

In some embodiments, the system includes a support assembly having a stanchion, wall mounting or other mounting that is other than totally vertical. In some embodiments, the system includes a support assembly having one or more non-vertical setting and a vertical setting of a stanchion, wall mounting or other mountings are set stations for summer and winter angles and are automatically adjust ideal solar collection angles by lengthening or shortening the length of the accordion device. In some embodiments, a nonvertical device mounting may be made to expose a greater amount of segments most appropriately to the collect energy.

In some embodiments, the system can use a smart phone, smart pad or other mobile computational and wireless device to direct the accordion solar and power storage device.

In some embodiments, a grouping of devices can be made to perform together using one directing processing system. In some embodiments, a grouping of devices can be wired together for relaying power. In some embodiments, a grouping of devices can be wirelessly connected together for information exchange.

In some embodiments, electronic components of the system may include wireless to be directed in orientation and open and close conditions. In some embodiments, the systems include wireless components useful to inform of the device status. In some embodiments, wireless communication features are provided for orientation or open and close condition directed by weather data parameter directed instructions to the device based on location of the device. In some embodiments, wireless communicates to the power collector (robot) to advise on power availability status. In some embodiments, wireless communicates with the user's smart phone or other processor device and be informed or directed by said remote device. In some embodiments, the power status and the user's schedule, weather, activities and other calculation of estimated power availability vs. estimated demand can inform, direct or in coordination with other collectors prepare devices for to meet demands required of activities or weather events.

In some embodiments, the system includes sensors used to direct the orientation or open and closed condition. In some embodiments, the system includes on-device sensors that inform directly the device's positioning.

In some embodiments, energy storage is used to heat the device so the device is deiced or removes snow.

In some embodiments, the system is configured to limit motion of the device based on obstructions.

In some embodiments, the energy storage components of the device has connection features.

In some embodiments, multiple devices are connected in series or in parallel. In some embodiments, the devices provide power to an automated guided vehicle (AGV or robot) while transferring energy to power-use devices such as EVs and facility operations or to another power storage device. In some embodiments, devices share power with other devices owned by another party or parties.

In some embodiment, the system includes a support assembly including a mounting device (stanchion, post, ground pin, cables, wall mounting, hooks etc.).

In some embodiments, accordion folding features are be integrated into the sandwich of the device. In some embodiments, flex circuit provides the folding feature of the device. In some embodiments, flex circuit provides the power connecting means between the segments of the accordion format. The flex circuit can, in some embodiments, have LED lights mounted to provide light to the area of the device. The LED lights may provide the user evidence of the energy storage status, an image or lettering, various colors, etc.

The folded accordion can collapse either upward or downward relative to the corresponding support assembly or mounting. In some embodiments, the system provides a cover for the upward or downward folded or stored condition.

In some embodiments, the system includes a support assembly having a stanchion or top segment with an LED light powered by the device. In some embodiments, the system is configured such that the device is automatically positioned for angle or orientation using GPS or other location data providing method such as a local smart phone. In some embodiments, the system is configured to issue a wireless or LED light warning of position change in progress, change in operation status, etc.

In some embodiments, the device is made from a grouping of segments and those segments use hinging connectors. In some embodiments, the device is configured such that a user may add or subtract to the number of segments. In some embodiments, hinging connectors between segments transfer power, data, etc.

In some embodiments, the device is composed of intermittent segments with and without photovoltaic layers. In some embodiments, the device is composed of intermittent segments that may or may not have power storage.

In some embodiments, the system further includes audio components.

In some embodiments, the system is configured to position the device using on-board sunlight sensors.

In some embodiments, the system includes features for manually opening/closing the device and removing the device from a support assembly.

In some embodiments, a grouping of devices are provided, with electronics associated with one device of the grouping controlling the positioning of other devices.

In some embodiments, the device includes a flex circuit that contacts more than one layer of an ultra-capacitor (or other power storage layer) to coordinate the use of power in sequence. The use of power from the ultra-capacitor energy storage can be governed by an algorithm.

In some embodiments, the system further includes a processor and related processing components. The processor can optionally be a smart phone.

In some embodiments, the system includes a processor or related logic components programmed to instruct a user on best positioning of the device.

In some embodiments, the system includes directions for assembling the device to a support assembly and locating photovoltaic layers of the device.

In some embodiments, the system includes a support assembly for supporting the device in at least the expanded state, with the system being configured such that the device is placed and replaced relative to the support assembly using an automated device.

In some embodiments, in the collapsed state, the device is useful as a battery and provides electrical connectors for a specific application. Optionally, the device in the collapsed state is useful as a battery for an electronic vehicle. In related embodiments, the device in the collapsed state can be rotated to and from the electronic vehicle and a corresponding support assembly.

In some embodiments, the system includes spacers between the segments of photovoltaic with power storage, with the spacers being configured to arrange the photovoltaic layers to optimally collect the most solar gain for the user's latitude. In some embodiments, the system is configured to adjust the angles of the accordion/expanded state during the year for optimal solar gain.

In some embodiments, the system includes two or more stanchions or wall mounts having cables between them and multiple devices are mounted to the cables. The cable-mounted device can optionally be oriented by the cable(s).

In some embodiments, the device includes a polyester flex circuit maintaining a sandwich arrangement of photovoltaic layers and power storage layers. In other embodiments, the flex circuit is a polyimide flex circuit.

In some embodiments, the power storage layer includes one or more LiON batteries.

In some embodiments, the power storage layer includes a graphene layer composed supercapacitor. In some embodiments, the power storage layer includes a polyurethane layer composed supercapacitor. In some embodiments, the power storage layer includes a graphene-graphite polyurethane composite supercapacitor.

In some embodiments, the system includes a support assembly including an automated motor-driven venetian blind mechanism.

In some embodiments, the photovoltaic layer is a flexible photovoltaic layer. In some embodiments, the photovoltaic layer is a photovoltaic layer referred to as “magic alloy”.

### BRIEF DESCRIPTION OF THE DRAWINGS

FIG. 1 is a simplified side view of a solar energy capture and store device in accordance with principles of the present disclosure and useful with systems of the present disclosure;

FIG. 2 is a perspective view of a system for collecting and storing solar energy in accordance with principles of the present disclosure;

FIG. 3A is a perspective view of a system for collecting and storing solar energy in accordance with principles of the present disclosure;

FIG. 3B is a front plan view of a portion of a solar energy capture and store device useful with the system of FIG. 3A in an expanded state;

FIG. 3C is a side view of the system of FIG. 3A;

FIG. 3D is a simplified side view of the solar energy capture and store device of FIG. 3B in a collapsed, folded state;

FIG. 4 is a perspective view of a solar energy collection and storage home installation using systems of the present disclosure;

FIG. 5 is a perspective view of a system for collecting and storing solar energy in accordance with principles of the present disclosure;

FIG. 6 is a perspective view of a system for collecting and storing solar energy in accordance with principles of the present disclosure;

FIG. 7 is a perspective view of a holder body useful with the system of FIG. 6;

FIG. 8 is a perspective view of a system for collecting and storing solar energy in accordance with principles of the present disclosure; and

FIG. 9 is a simplified side view of a solar energy capture and store device useful with the system of FIG. 8 and in a collapsed, folded state.

### DETAILED DESCRIPTION

Some aspects of the present disclosure are directed to systems, devices and methods for capturing and storing solar energy. In general terms, the systems of the present disclosure include a solar energy capture and store device that is configured to be transitionable between a collapsed, folded state (e.g., for compact storage) and an expanded state (e.g., for capturing solar energy). As described in greater detail below, the systems can optionally further include a support assembly configured to maintain the solar energy capture and store device in an expanded state when gathering solar energy, along with optional mechanisms or other features that facilitate operation of the device (e.g., in tracking apparent movement of the sun). The systems and devices of the present disclosure can be highly conducive to simplified installation and operation, well-suited for a DIY user.

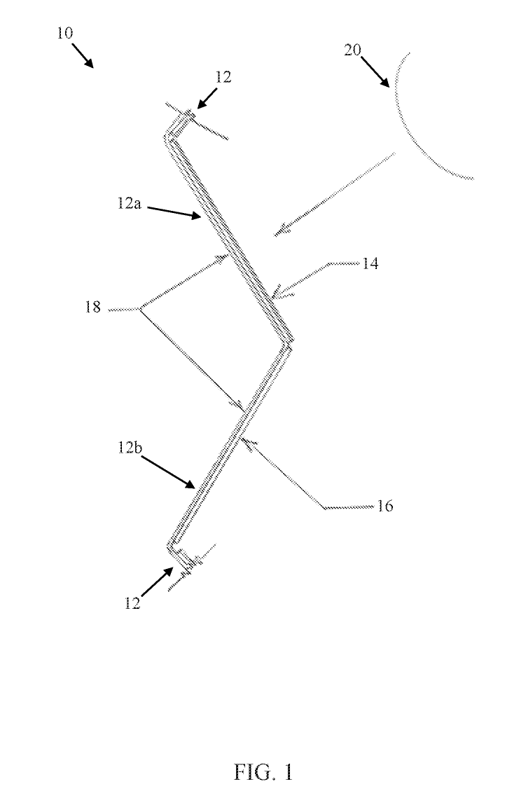

With the above in mind, a portion of one embodiment of a solar energy capture and store device 10 is shown in FIG. 1. The device 10 generally includes or is formed to define a plurality of segments 12 (two of which are shown in FIG. 1 at 12a and 12b) arranged in a contiguous row. Immediately adjacent ones of the segments 12 are hinged or pivotably secured to one another such that the device 10 can be collapsed, for example in an accordion-style fashion, from an expanded state represented by FIG. 1 to a collapsed, folded state as described in greater detail below. At least one of the segments 12 of the device 10 carries a photovoltaic layer 14, and at least one of the segments 12 carries a power storage layer 16. In some embodiments, every other one of the segments 12 of the device 10 are provided with a photovoltaic layer 14, although more or less is also acceptable. In some embodiments, a majority, optionally all, of the segments 12 of the device 10 are provided with a power storage layer 16. Regardless, an electronic connection 18 is established between each immediately adjacent pair of segments 12, transferring energy from the corresponding power storage layer 16 to an electrical connections terminus (not shown in FIG. 1) at which an electrical device can draw stored energy from the device 10.

As reflected by FIG. 1, in the expanded state, the device 10 can be arranged such that the photovoltaic layers 14 are exposed to sunlight from the sun 20. The photovoltaic layer(s) 14 are electrically connected to at least one power storage layer 16; the so-collected energy is transferred to, and stored by, the power storage layer 16.

The photovoltaic layers 14 can assume any form known in the art conducive to collecting solar energy and can generally include solar cells. In some embodiments, the photovoltaic layers 14 can include concentrator photovoltaics formatted from a semiconductor alloy that can capture the near-infrared light located on the leading edge of the visible light spectrum (sometimes referred to in the literature as a “magic alloy” as described in “Bi-enhanced N incorporation in GaAsNBi alloys” published Jun. 15, 2017 in Applied Physics Letters, and “Influence on surface reconstruction on dopant incorporation and transport properties of GaAs(Bi) alloys” published Dec. 26, 2016 in Applied Physics Letters, the entire teachings of both of which are incorporated herein by reference).

The power storage layers 16 can assume any form known in the art conducive to storing energy. In some embodiments, the power storage layers 16 can include nano-ultra capacitors. Some non-limiting examples are described in “Graphene-Graphite Polyurethane Composites based High-Energy Density Flexible Supercapacitors” as published in Advanced Science, the entire teachings of which are incorporated herein by reference. In other embodiments, the power storage layers 16 can include small-scale LiON batteries.

The electronic connections 18 can be established in various fashions. In some embodiments, each individual segment 12 is configured to be secured to another segment 12 in a manner that establishes an electrical connection and that allows the two segments 12 to pivot or fold relative to one another in a hinge-like fashion. In other embodiments, the electronic connections 18 can be established by a flex circuitry structure as is generally known in the art. The flex circuitry structure provides the necessary electrical connections, as well as establishes a footprint for each of the segments 12 in a manner; flex circuitry structures have sufficient robust flexibility to permit immediately adjacent ones of the so-established segments 12 to pivot or fold relative to one another.

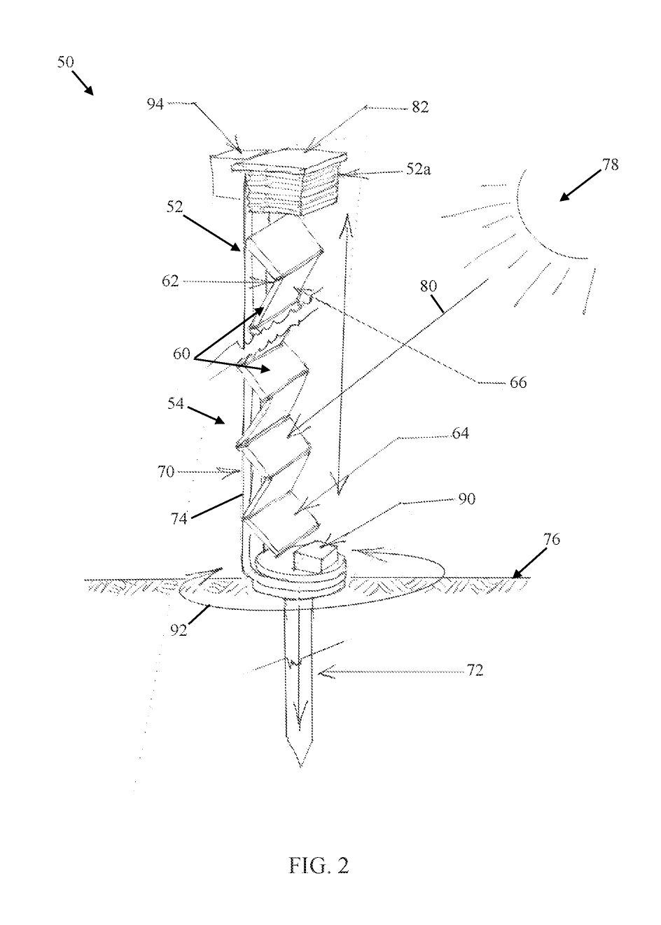

With the above understanding of one embodiment solar energy capture and storage device in mind, one embodiment of a system for capturing and storing solar energy 50 in accordance with principles of the present disclosure is shown in FIG. 2. The system 50 includes a solar energy capture and storage device 52 and a support assembly 54 (referenced generally). In general terms, the device 52 is mounted to and supported by the support assembly 54, and is transitionable between an expanded state and a collapsed, folded state (identified at 52a in FIG. 2).

The device 52 can assume any of the forms described above and generally includes or defines a plurality of segments 60. The segments 60 are arranged in a contiguous row, with immediately adjacent ones of the segments 60 being foldable relative to one another (identified, for example, by a hinge 62 in FIG. 2) in a manner that maintains electrical connections across the segments 60. The foldable arrangement of the device 52 can be in an accordion-like fashion as shown. One or more of the segments 60 carries a photovoltaic layer 64. With the non-limiting example of FIG. 2, a photovoltaic layer 64 is provided with every other one of the segments. One or more of the segments 60 carries a power storage layer 66. With the non-limiting example of FIG. 2, a power storage layer 66 is provided with all, or nearly all, of the segments 60.

The support assembly 54 is configured to support the device 52 in at least the expanded state and in some embodiments includes a stanchion 70 and a stake or pin 72. The stanchion 70 has a structurally robust construction, appropriate for maintaining a vertical orientation of an upright member 74 under a weight of the device 52 (and other optional components). The stake 72 is coupled to the stanchion 70 and is configured for insertion into ground 76. With this construction, the system 50 is easily installed to virtually any outdoor locale; a user inserts the stake 72 into the ground 76 (e.g., by stepping on the stake 72). The upright member 74 is thus generally vertically oriented relative to the ground 76. The device 52 is mounted to the stanchion 70, and can thus be supported in a selected expanded state by the stanchion 70. When so assembled and arranged, the segments 60 otherwise carrying a photovoltaic layer 64 are situated relative to the sun 78 such that the corresponding photovoltaic layer 64 is exposed to, and thus collects energy of, sunlight 80 from the sun 78. In some embodiments, the stanchion 70 can include a cap or cover 82 configured to retain the device 52a in the collapsed, folded state.

In some embodiments, the stanchion 70 is rotatably coupled to the stake 72, affording a user the ability to manually orient the device 52 (e.g., rotating the stanchion 70, and thus the device 52, relative to the stake 72) as desired relative to the sun 78. Optionally, the system 50 can further include a rotation actuator (e.g., a motor) 90 that automatically rotates the stanchion 70 relative to the stake 72, and optionally operates to hold the stanchion 70 at a selected rotational position relative to the stake 72. With these and related constructions, the system 50 can operated such that the device 52 tracks apparent movement of the sun 78 (e.g., operating the rotation actuator 90 to rotate the stanchion 70, and thus the device 52, relative to the stake 72) as indicated by arrow 92. The rotation actuator 90 can assume various forms as known in the art, and can be assembled to the stanchion 70 and/or the stake 72 at various locations. The rotation actuator 90 can be prompted to operate in various manners. In some embodiments, the rotation actuator 90 is controlled by on-board logic programmed with expected sun locations at the particular installation site. In other embodiments, the rotation actuator 90 can be remotely (e.g., wirelessly) controlled based on various parameters, such as, for example, a weather information website.

In some embodiments, the system 50 can optionally include a vertical actuator (e.g., a motor) 94 that automatically collapse or expands the device 50. The vertical actuator 94 can assume various forms as known in the art, and can be assembled to the stanchion 70 at various locations. The vertical actuator 94 can be prompted to operate in various manners. In some embodiments, the vertical actuator 94 is controlled by on-board logic programmed with expected sunrise and sunset times at the particular installation site. In other embodiments, the vertical actuator 94 can be remotely (e.g., wirelessly) controlled based on various parameters, such as, for example, a weather information website.

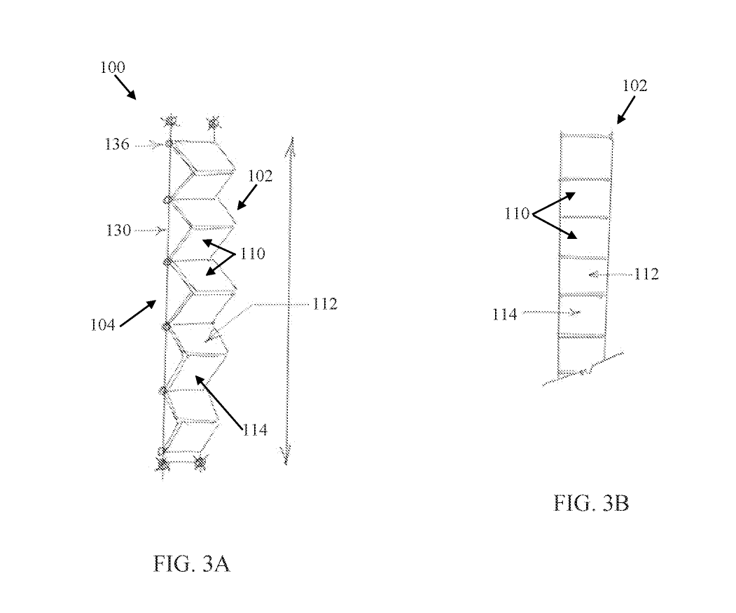

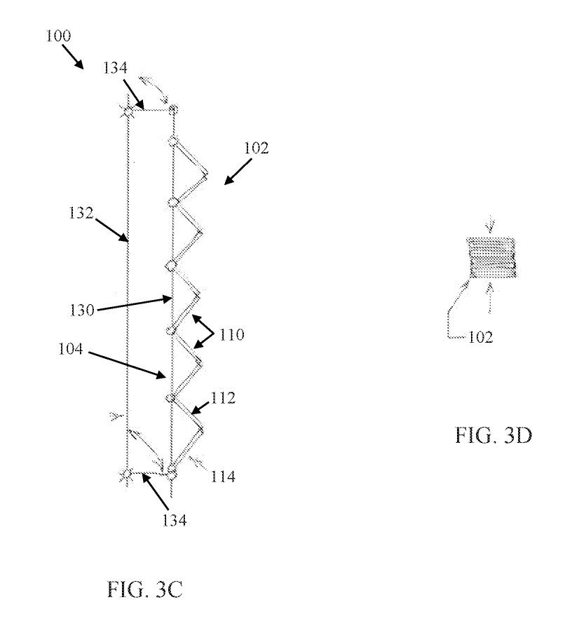

Another embodiment of a system for capturing and storing solar energy 100 in accordance with principles of the present disclosure is shown in FIGS. 3A-3D. The system 100 includes a solar energy capture and storage device 102 and a support assembly 104 (referenced generally). In general terms, the device 102 is mounted to and supported by the support assembly 104, and is transitionable between an expanded state (FIGS. 3A-3C) and a collapsed, folded state (FIG. 3D).

The device 102 can assume any of the forms described above and generally includes or defines a plurality of segments 110. The segments 110 are arranged in a contiguous row, with immediately adjacent ones of the segments 110 being foldable relative to one another as shown in a manner that maintains electrical connections across the segments 110. The foldable arrangement of the device 102 can be in an accordion-like fashion as shown. One or more of the segments 110 carries a photovoltaic layer 112. With the non-limiting example of FIGS. 3A-3D, a photovoltaic layer 112 is provided with every other one of the segments. One or more of the segments 110 carries a power storage layer 114. With the non-limiting example of FIG. 3A-3D, a power storage layer 114 is provided with all, or nearly all, of the segments 110. In some embodiments, the electrical connections across the segments 110 can be established by a single reel-to-reel polymer flex circuit with formed hinge or pivot lines between immediately adjacent ones of the segments 110.

The support assembly 104 can assume various forms and in some embodiments includes one or more cables 130 configured to be mounted or affixed to a wall 132 (e.g., by support arms 134). The device 102 can be connected to the cables 130 by connectors 136, for example at every other hinge point between immediately adjacent ones of the segments 110. One or more of the support arms 134 can be pivotably mounted relative to the wall 132, affording a user the ability to arrange the device 102 at a desired fold orientation appropriate for a particular location of the sun. In some optional embodiments, the system 100 can include one or more actuators (e.g., motors) that operate to dictate an orientation of the support arms 134. The actuator(s) can be remotely operated based upon various parameters or information as described above. With these and related embodiments, the system 100 can be operated to adjust an orientation of the photovoltaic layer-carrying segments for optimize solar energy collection, for example based on a latitude and/or season of the particular installation site.

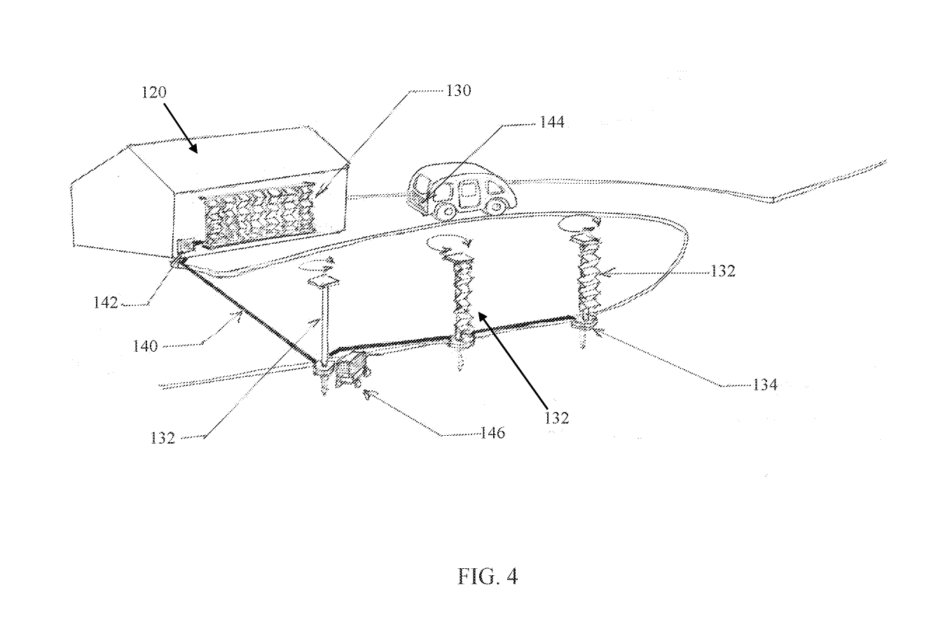

In some embodiments, multiple ones of the systems for collecting and storing solar energy can be easily installed at various locations at a user's home 120 or property. For example, FIG. 4 illustrates a first system 130 (e.g., the system 100 of FIGS. 3A-3D) is installed to a wall of the user's home 120, and additional systems 132 (e.g., the system 50 of FIG. 2) are installed into the ground at the user's property (e.g. via a support assembly 134 labeled for one of the systems 132). The systems 130-132 can assume any of the forms described in the present disclosure and in some embodiments are all electrically connected to a power grid 140 that provides an electrical terminus 142 at the user's home 120. A vehicle 144 can be configured to receive one or more of the solar energy collect and store devices associated with the systems 130-132, and operates to use power provided thereby. Further, a robotic pick and place device 146 can be provided that automatically retrieves and/or returns the solar energy collect and store device from/to the corresponding support assembly.

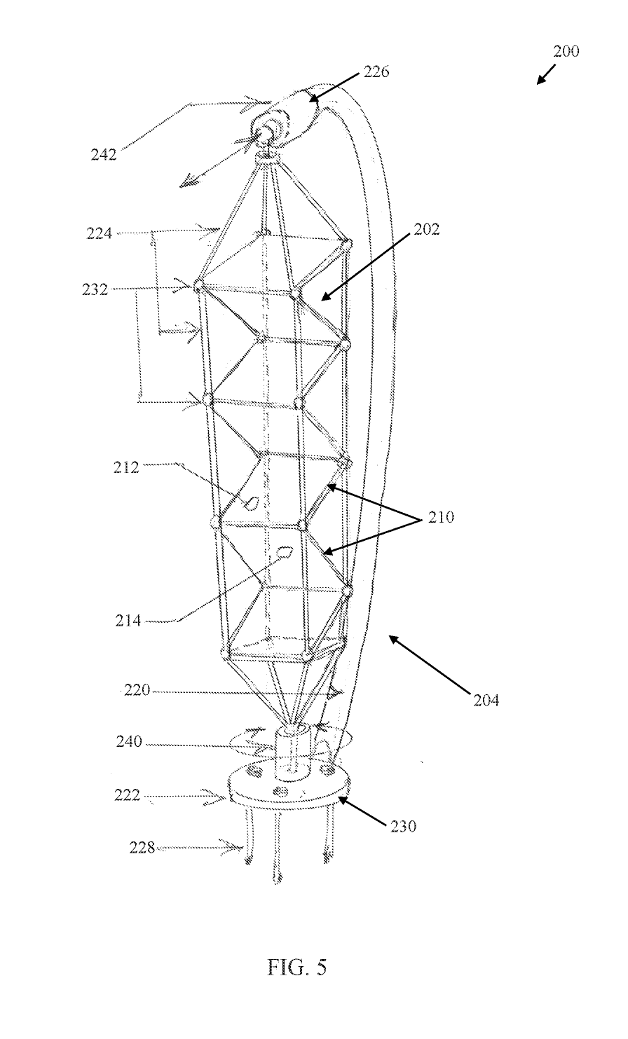

Another embodiment of a system for capturing and storing solar energy 200 is shown in FIG. 5. The system 200 includes a solar energy capture and storage device 202 and a support assembly 204 (referenced generally). In general terms, the device 202 is mounted to and supported by the support assembly 204, and is transitionable between an expanded state and a collapsed, folded state (not shown).

The device 202 can assume any of the forms described above and generally includes or defines a plurality of segments 210. The segments 210 are arranged in a contiguous row, with immediately adjacent ones of the segments 210 being foldable relative to one another as shown in a manner that maintains electrical connections across the segments 210. The foldable arrangement of the device 202 can be in an accordion-like fashion as shown. One or more of the segments 210 carries a photovoltaic layer 212. One or more of the segments 210 carries a power storage layer 214. In some embodiments, the electrical connections across the segments 210 can be established by a flex circuit with formed hinge or pivot lines between immediately adjacent ones of the segments 210.

The support assembly 204 can include a stanchion 220, a support device 222, and one or more cables 224. The stanchion 220 is coupled to the support device 222, extending from the support device 222 to a leading end 226. The support device 222 is configured to be readily mounted into ground (e.g., via stakes or pins 228 projecting from a stabilizer plate 230). The cables 224 extend between the leading end 226 and the support device 222. The segments 210 are mounted to the cables 224 by snap connectors 232 at, for example, fixed locations. An optional rotation actuator 240 (e.g., a motor) is operable to rotate the stanchion 220, and thus the device 202, relative to the support device 222 (and thus relative to the sun). An optional upper actuator 242 (e.g., a motor) is operable to extend or collapse (partial or complete) the device 202. With this example construction, a more uniform angle of orientation can be established across the segments 210. Alternatively or in addition, the upper actuator 242 can operate to move an upper end of the device 202 horizontally, thereby altering an orientation or attitude of each of the segments 210 relative to ground.

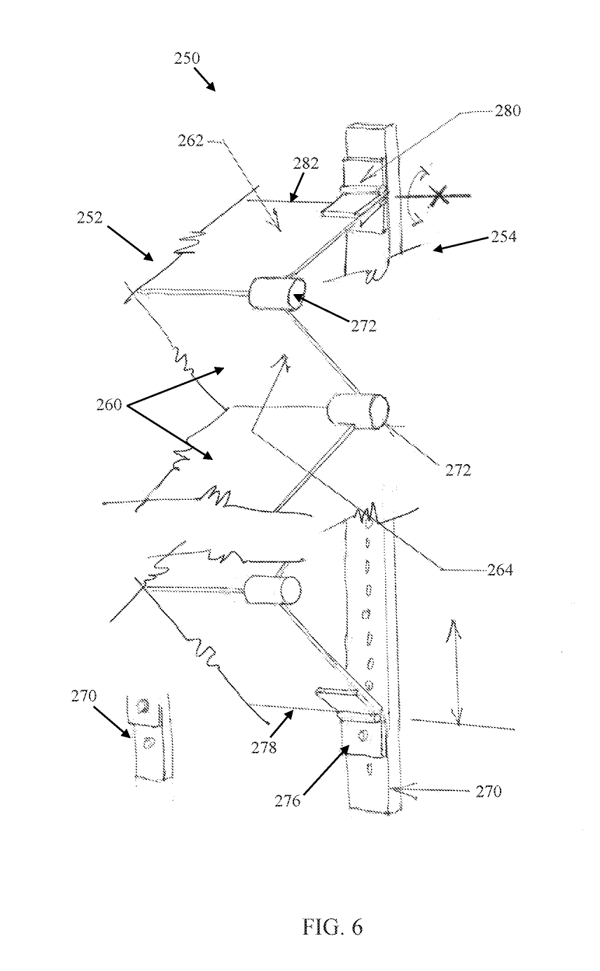

Portions of another embodiment of a system for capturing and storing solar energy 250 is shown in FIG. 6. The system 250 includes a solar energy capture and storage device 252 and a support assembly 254 (referenced generally). In general terms, the device 252 is mounted to and supported by the support assembly 254, and is transitionable between an expanded state and a collapsed, folded state (not shown).

The device 252 can assume any of the forms described above and generally includes or defines a plurality of segments 260. The segments 260 are arranged in a contiguous row, with immediately adjacent ones of the segments 260 being foldable relative to one another as shown in a manner that maintains electrical connections across the segments 260. The foldable arrangement of the device 252 can be in an accordion-like fashion as shown. One or more of the segments 260 carries a photovoltaic layer 262. One or more of the segments 260 carries a power storage layer 264. In some embodiments, the electrical connections across the segments 260 can be established by a flex circuit with formed hinge or pivot lines between immediately adjacent ones of the segments 260.

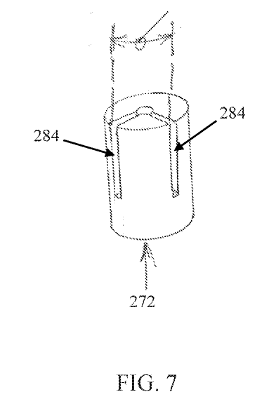

The support assembly 254 can include one or more brackets 270 and a plurality of holder bodies 272. The bracket(s) 270 are configured for mounting to a wall. A bottom clip 276 connects a lower end 278 of the device 252 with the bracket 270, and a top clip 280 connects an upper end 282 of the device 252 with the bracket 270. At least one of the holder bodies 272 (e.g., rubber material) is coupled at the hinge line between immediately adjacent ones of the segments 260. For example, as shown in FIG. 7, each of the holder bodies 272 can include slits 284 sized to slidably receive a corresponding one of the segments 260, maintaining the neighboring segments 260 at a selected angular orientation. Upon final assembly and as shown in FIG. 6, the device 252 is retained in an expanded state, with a relatively uniform angle between adjacent pairs of the segments 260. In some embodiments, different holder bodies 272 can be provided having differing slit angles to achieve a desired angular orientation appropriate for an expected location of the sun (e.g., varying by season). Further, the bracket 270 can configured such that a vertical location of the bottom clip 276 can be varied to again achieve a desired angular orientation appropriate for an expected location of the sun.

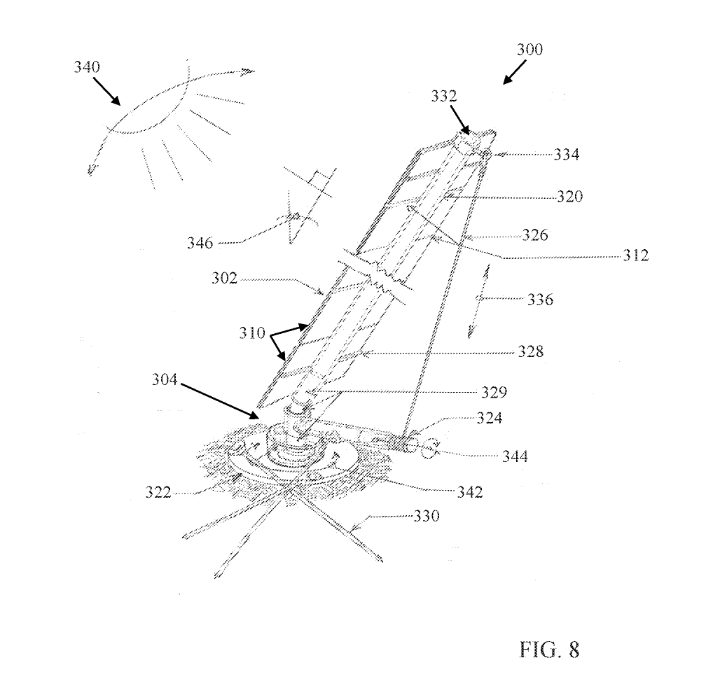

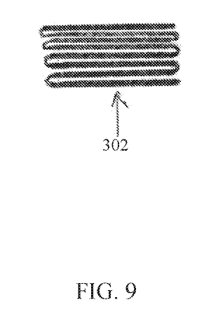

Another embodiment of a system for capturing and storing solar energy 300 is shown in FIG. 8. The system 300 includes a solar energy capture and storage device 302 and a support assembly 304 (referenced generally). In general terms, the device 302 is mounted to and supported by the support assembly 304, and is transitionable between an expanded state and a collapsed, folded state (FIG. 9).

The device 302 can assume any of the forms described above and generally includes or defines a plurality of segments 310. The segments 310 are arranged in a contiguous row, with immediately adjacent ones of the segments 310 being foldable relative to one another as shown (e.g. a hinge 312) in a manner that maintains electrical connections across the segments 310. The foldable arrangement of the device 302 can be in an accordion-like fashion as shown. One or more of the segments 310 carries a photovoltaic layer. One or more of the segments 310 carries a power storage layer. In some embodiments, the electrical connections across the segments 310 can be established by a flex circuit with formed hinge or pivot lines between immediately adjacent ones of the segments 310.

The support assembly 304 can include a stanchion 320, a base plate 322, a support arm 324 and a cable 326. The device 302 is mounted to the stanchion 320, for example via optional mounting brackets 328. In some embodiments, the stanchion 320 can have a flexible portion 329 (referenced generally) with vertical memory. The stanchion 320 is coupled to the base plate 322 that in turn can be affixed to ground (e.g., via stakes 330). In some embodiments, the stanchion 320 is rotatable relative to the base plate 322. The support arm 324 extends from the stanchion 320. The cable 326 extends from the support arm 324 and is coupled to an opposite or leading end 332 of the stanchion 320, for example via a clevis 334. In some embodiments, a length of the cable 326 between the support arm 324 and the leading end 332 is adjustable in a direction of the arrow 336, for example by winding the cable 326 around the support arm 324.

With the above construction, a rotational orientation the device 302 relative to the sun 340 can be adjusted by rotating the stanchion 320 relative to the base plate 322. Optionally, a rotation actuator 342 (e.g., a motor) is provided that causes rotation in a desired manner. Further, an angle of the device 302 relative to the sun 340 can be adjusted by increasing or decreasing a length of the cable 326 between the support arm 324 and the leading end 332 of the stanchion 320. Optionally, an angle track actuator 344 (e.g., a motor) is provided that rotates the support arm 324 in a desired direction to wind or un-wind the cable 326, in turn altering an angle of the device 302 relative to the sun 340 as indicated by the arrow 346. The actuator(s) can be remotely (e.g., wirelessly) controlled based on various inputs or parameters as described above.

Although the present disclosure has been described with reference to preferred embodiments, workers skilled in the art will recognize that changes can be made in form and detail without departing from the spirit and scope of the present disclosure.

1. A system for capturing and storing solar energy, the system comprising:
a solar energy capture and store device including:
a plurality of segments arranged in a contiguous row, wherein immediately adjacent ones of the segments are interconnected by a hinge such that the plurality of segments are transitionable between a collapsed, folded state and an expanded state, wherein the plurality of segments includes a first segment, a second segment, and a third segment, the first and second segments connected to the third segment at opposite sides thereof;
a first photovoltaic layer carried by the first segment;
a second photovoltaic layer carried by the second segment;
a power storage layer carried by at least one of the plurality of segments and electrically connected to at least one of the first and second photovoltaic layers;
an electronic connection between each immediately adjacent pair of segments of the plurality of segments; and
an electrical connections terminus carried by at least one of the plurality of segments for delivering stored energy.

2. The system of claim 1, wherein at least every other one of the plurality of segments caries a photovoltaic layer.

3. The system of claim 1, wherein a footprint of the device in the collapsed, folded state is less than a footprint of the device in the expanded state.

4. The system of claim 1, wherein further comprising flex circuitry establishing the segments and the electronic connections.

5. The system of claim 4, wherein the flex circuitry is contiguous through the segments and connect to the power storage layer.

6. The system of claim 5, wherein the device is configured such that the segments are heated by stored power that energizes a portion of the flex circuitry.

7. The system of claim 1, further comprising:
a support assembly configured to support the device in the expanded state.

8. The system of claim 7, wherein the support assembly includes a stanchion is configured to be affixed to ground.

9. The system of claim 8, wherein the stanchion is configured to flex.

10. The system of claim 7, wherein the support assembly includes at least one cable configured for mounting to a wall.

11. The system of claim 7, further comprising:
a motor mechanically coupled to the support assembly to rotate the device in tracking the sun.

12. The system of claim 7, wherein the support assembly and the device are configured such that when the device is supported by the support assembly and the device is in the expanded state, the first and second segments are angled relative to earth such that the corresponding photovoltaic layers capture solar energy.

13. The system of claim 7, wherein the support assembly is configured to manipulate an arrangement of the device according to an amount of solar energy gain.

14. The system of claim 7, wherein the support assembly comprises markings designating an arrangement of the plurality of segments relative to a corresponding latitudinal position.

15. The system of claim 1, further comprising a sensor carried by the device and for directing operation of the device.

16. The system of claim 1, wherein the device is configured to operate in response to wireless signals.

17. The system of claim 1, wherein the device is configured to operate in response to information received from a remote weather monitoring system.

18. The system of claim 1, wherein the power storage layer comprises a solid-state power storage unit.

19. The system of claim 1, wherein the first and second photovoltaic layers each include multiple concentrators with an equal number of dish reflectors.

20. The system of claim 1, wherein each of the plurality of segments have a substantially similar length and width.
